(19) United States
(12) Patent Application Publication
(10) Pub. No.: US 2016/0364691 A1
(43) Pub. Date: Dec. 15, 2016

(54) SYSTEM AND METHOD FOR PREDICTIVE PRE-EMPLOYMENT SCREENING

(71) Applicants: Tyler Foxworthy, Indianapolis, IN (US); John Roach, Indianapolis, IN (US); Charlie Brandt, Indianapolis, IN (US); Tyler Foxworthy, Indianapolis, IN (US)

(72) Inventors: Tyler Foxworthy, Indianapolis, IN (US); John Roach, Indianapolis, IN (US); Charlie Brandt, Indianapolis, IN (US); Tyler Foxworthy, Indianapolis, IN (US)

(21) Appl. No.: 14/737,040

(22) Filed: Jun. 11, 2015

(51) Int. Cl. G06Q 10/10; G06N 99/00; G06N 5/04

(52) U.S. Cl. CPC G06Q 10/1053; G06N 5/04; G06N 99/005

(57) ABSTRACT

A computerized method and system for pre-employment predictive screening is disclosed. The method comprises aggregating a plurality of employee testing and demographic data in a database, mapping each data in the plurality of employee testing and demographic data to a faceted feature space, selecting a classifying facet group from the faceted feature space, training a classifier model based at least in part on the classifying facet group, and saving the classifier model to a memory.

### CROSS REFERENCE TO RELATED APPLICATION

The present application claims the benefit of and incorporates by reference herein the disclosure of U.S. Provisional Patent Application Ser. No. 62/010,683 filed Jun. 11, 2014.

### BACKGROUND

Recruiting and keeping the right talent is a difficult task for many businesses. Finding the right talent often requires a true investment from the company in effort and dollars, including a recruiting team to seek out the right talent, payment to listing services, and, in some cases, fees paid out to third party recruiters. After recruiting the right talent, the business takes an additional gamble that the individual will stay for a long enough period of time such that the business sees a return on the investment put into the recruitment process. With the recruitment market shifting from the career-long worker prevalent twenty to thirty years ago to employees that change positions frequently, the importance of recruiting and retaining the right talent is more important today than ever before.

Pre-employment screening is one tool that employers use to try to find and hire talent. Employers regularly require job seekers to complete standard application material as well as submit skills-based and personality questionnaires online. The use of personality testing in the workplace has been the subject of significant research and debate for decades. However, existing platforms for predicting employee outcomes based on testing are fundamentally limited by the use of outdated statistical methods and are mostly geared for cultural fit with the organization and fail to address employee retention. For example, the trucking industry, where driver safety and retention are particularly critical, the pre-employment screening process has yet to find a way to filter out risky applicants.

The issue is not that the information is unavailable. The issue with previous models is that they fail to ask the right questions and derive the right results. Accordingly, there exists a need for a system and method for predictive pre-employment screening.

### BRIEF DESCRIPTION OF THE DRAWINGS

FIG. 1A illustrates a flowchart of a method for predictive pre-employment screening according to at least one embodiment of the present disclosure.

FIG. 1B illustrates a flowchart of a method for predictive pre-employment screening according to at least one embodiment of the present disclosure.

FIG. 2 displays the architecture of a system for predictive pre-employment screening according to at least one embodiment of the present disclosure.

FIG. 3 displays a combination flowchart of a method and components in an architecture of a system for predictive pre-employment screening according to at least one embodiment of the present disclosure.

FIG. 4 displays an exemplary execution of a method on a system for predictive pre-employment screening according to at least one embodiment of the present disclosure.

FIG. 5 displays an exemplary execution of a method on a system for predictive pre-employment screening according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in any programming language—interpreted, compiled, or otherwise. These languages may include, but are not limited to, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Node.js, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services, application programming interfaces and/or service-oriented architecture through one or more application programming interfaces or otherwise.

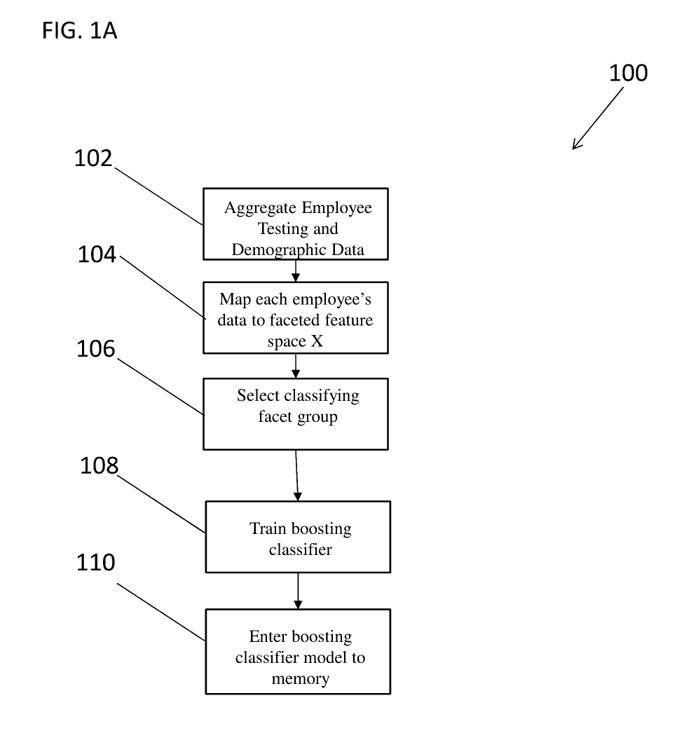

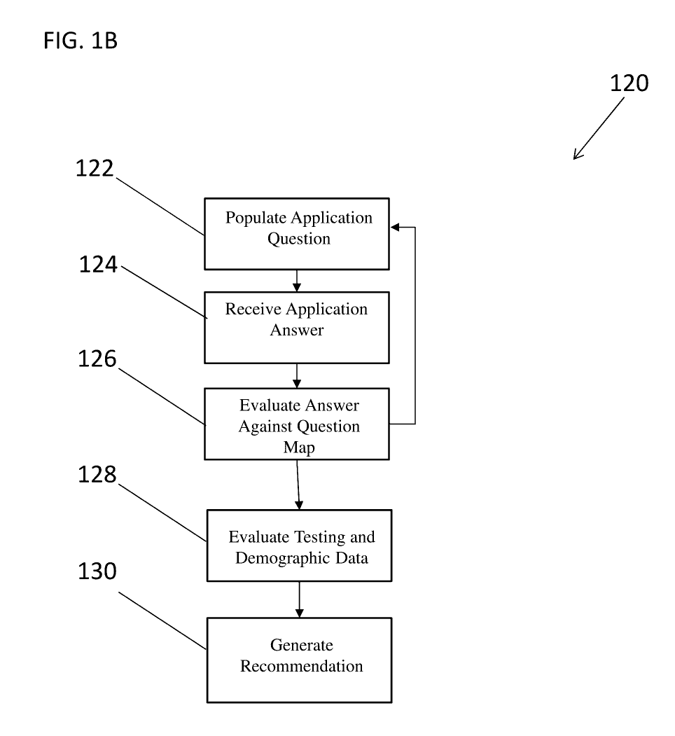

Referring now to FIG. 1, it is shown a flowchart of a method 100 for predictive pre-employment screening according to at least one embodiment of the present disclosure. As shown in FIG. 1, the method 100 includes aggregating employee testing and demographic data in step 102, mapping each employee's data to a faceted feature space X in step 104, select a classifying facet group in step 106, training a boosting classifier in step 108, and entering the boosting classifier model to a memory in step 110.

Predicting retention, safety, and other characteristics important to the hiring process may be done based on demographic and personality co-variates using enterprise data and machine learning. The method 100 describes steps that prepare a machine learning meta-algorithm according to at least one embodiment of the present disclosure. In step 102, employee testing and demographic data is aggregated into a data structure, like a data warehouse, enterprise data center, Hadoop infrastructure, and any other data store that may be accessed over a computer network, to name a few non-limiting examples.

In step 104, each employee's data is mapped to a faceted feature space X. It should be appreciated that this step 104 may be performed upon receipt of any individualized employee testing and demographic data (i.e. answer to a particular question) or may be mapped using a preexisting data set. In at least one embodiment of the present disclosure, in step 104, the pre-employment screening method consistently maps a vector of apriori applicant data xεX to a discrete future state yε3) via a function H(x) learned on a large set of training data (x1, y1), . . . , (xn, ym) (i.e. data aggregated in step 102); alternately stated, it is a supervised machine learning system that represents existing employees and applicants in an abstract feature space X⊂[0, 1]n where there exists a mapping to a set of outcome states 3).

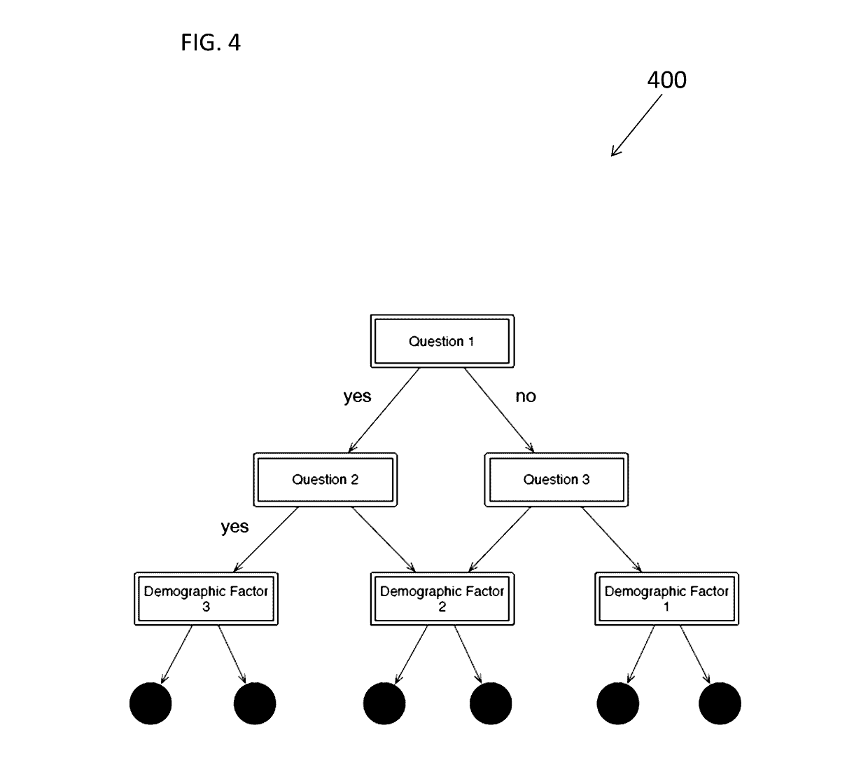

In step 106, a classifying facet group is selected to form H(x). An example of a faceted feature space H(x) is shown in example 400 in FIG. 4. As shown in FIG. 4, the example 400 is a taxonomy of employee demographic data based on responses to questions and a deterministic mapping of factors to a finite group of outcomes. It should be appreciated that, for use in pre-employment predictive screening, the boolean nature of decision-trees make them far more amenable to interpretation than “black-box” techniques such as neural networks and support vector machines, whose mechanism and results are difficult to interpret or visualize.

In step 108, a boosting classifier, and more particularly, an adaptive boosting classifier is trained based on the H(x) mapping described herein. Given the discrete nature of the problem, using Adaptive Boosting (AdaBoost), a machine learning meta-algorithm, to generate the classifier H(x) is advantageous because AdaBoost is an iterative machine learning technique that relies on ensembles of “weak learners” whose predictions over weighted subsets of the training dataset are added resulting in a “strong” classifier. In short, the AdaBoost algorithm trains the classifiers Hₘ(x) on weighted versions of the training sample, giving higher weight to cases that are currently misclassified. This is done for a sequence of weighted samples, and then the final classifier is defined to be a linear combination of the classifiers from each stage. When combined with tree-based base-classifiers, AdaBoost has been critically touted as the best off-the-shelf classification algorithm available to-date. It will be appreciated that other classification and boosting technologies and mechanisms may be used. In step 110, the boosting classifier model is saved to memory.

Referring now to FIG. 1B, it is shown a method 120 for predictive pre-employment screening according to at least one embodiment of the present disclosure. As shown in FIG. 1B, the method 120 includes populating an application question in step 122, receiving an application answer in step 124, evaluating an answer against a question map in step 126, evaluating testing and demographic data based on the answer in step 128, and generating recommendations in step 130. It should be appreciated that the question and answer process may include multiple question and answer sets such that the step 122, 124, and 126 may be repeated.

In step 122, a system populates an application question to be answered by a potential employee. The question and answer interface may follow and be visually reminiscent of existing standard mobile, web, and desktop based testing designs. The system populates questions on screen and present an interface for either selecting a pre-populated response or a dialog for entering a free form text response. Skills based tests may optionally display reference material in a side-bar or minimized view.

In step 124, the testing interface receives answers to the question from the potential employee. In addition, the testing interface programmatically records the following data from each user: User name, email, and relevant pre-employment information; Question and answer pairs; Time-series data for question-response and resource specific reference access; and IP address and browser user-agent identification string. In addition, at the beginning of test administration, potential employees will be prompted to provide normal personal information required for job applications. Users interact with the system through a web-browser or mobile device.

In step 126, the potential employee's answer to the question and additionally obtained information is evaluated against a question map to determine the next question to ask. These question and response sets are pre-populated by the system administrator and stored in memory. Potential employees may toggle between questions and respond in any order they choose, as this choice may be statistically significant in some contexts. Questions may be either job skill or personality driven.

It should be appreciated that the question and answer system may obtain additional information during interaction by a potential employee. For example, the platform allows administrators the option of allowing reference material in same view, collection of server logging information (i.e. HTTP header), and other information. This metadata, including reference lookups, are logged in a similar manner to question and answer pairs and used as additional feature metadata within the data mapping.

It should be appreciated that the manner in which an applicant responds to questions is a significant source of metadata with considerable predictive power in relevant contexts; capturing only question and answer data omits potentially valuable information relevant to both the test-taker and the prospective employer. Of course, to effectively capture the temporal nature of the test taking process, a graph-based data structure that facilitates large-scale aggregation and data mining is needed and is part of the taxonomy described herein.

In this data structure, the test taker, the questions presented, all potential responses, and all potential resources are represented as discrete and uniquely indexed nodes. In at least one embodiment of the present disclosure, time segments may be represented as nodes of a type (i.e. “FRAME”) which can be connected to nodes representing other hierachical time units. This data structure enables the taxonomy to represent the temporal properties in which a test is taken as well as the question/answer pairs as an ordered traversal of a finite graph. It should be appreciated, then, when steps 122, 124, and 126 are repeated based on responses to previous questions, the order in which questions are served to the potential employee may be dynamically generated as a function of user demographics and updates on a question by question basis. This initial mapping is accomplished via a self-organizing map algorithm, which identifies finite demographic clusters in aggregated data.

The graph formalism described for the testing platform can be extended to sort through the complex web of organizational data such as reporting hierarchies, employee information, events such as accidents, client relationships, etc. It should further be appreciated that the data platform has generalizable extract-trasform-load (ETL) processes for powering advanced data mining and reporting capabilities alongside existing legacy data systems. Historical data is integrated to initialize the system based on a predefined ETL process centered around individuals and events in data. For example, individuals within the organization are represented as nodes, which are labeled by role and indexed by name or unique identifier. A node representing finite events is labeled categorically and indexed by unique identifier and are connected to timelines and discrete time frame sequences. These individual nodes, then, may be connected to events. In some embodiments, organization hierarchies, reporting and collaboration structures are connected by labeled edge relationships.

Upon test completion, the process data is transferred to a central data repository and the data evaluated by a cached instance of a trained pre-employment qualification model in step 128. Based on the pre-employment qualification model, a recommendation to hire or not hire is generated by the system in step 130.

In conducting an experiment of the benefits of the methods and systems described herein, an analysis of 690 employee records (in this illustrative example, truck drivers were the employees) obtained from a large truckload carrier indicated that approximately 60 percent of all new hires leave or are terminated within 6 months, wherein half of termed employees leave within the first 4 months. The dataset includes demographic as well as personality test results.

When executing the methods described herein to create an Boosting classifier and evaluate against the metrics, the model obtained is efficient over prior art methods at identifying individuals who are likely to quit within the first year of employment with only minimal Type 1 error. This is an important property of the model because it will drive down the cost associated with high turnover. While relatively high, the Type 2 error (e.g. risk of not hiring a driver who would stay past 1 year based on the algorithm) will present to increase cost to businesses employing this model. To evaluate the robustness of the model to new data, the algorithm training process was repeated 100 times while splitting the available data equally into training and testing datasets; the out-of-bag error is the metric which describes how similar the performance of the model was over each iteration. The out-of-bag error obtained is very low compared to other real world applications and conventionally known methods, which indicates that the model will generalize well to external data and other data sets.

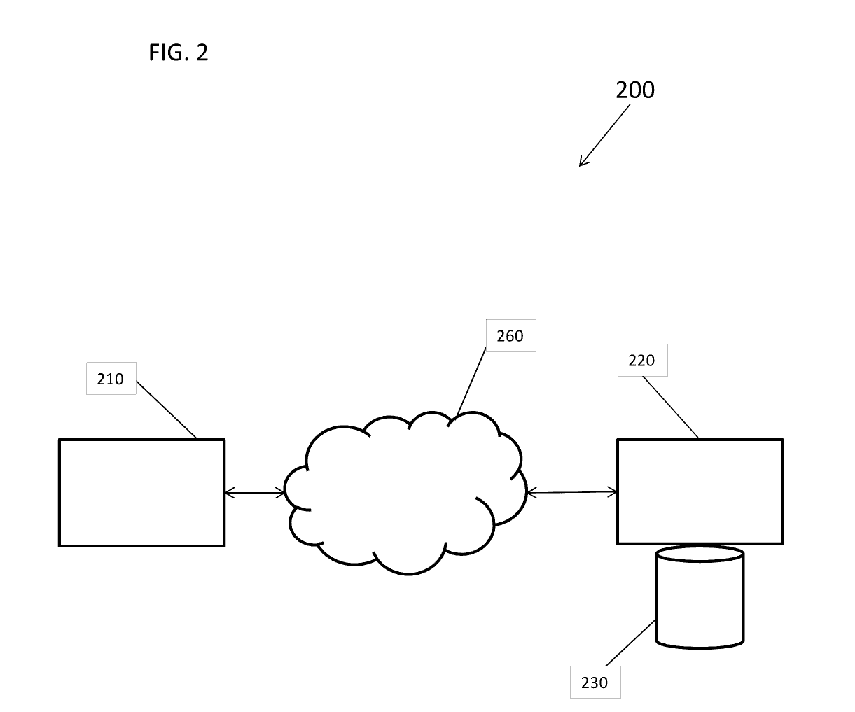

Referring now to FIG. 2, there is shown at least one embodiment of the components of the system 200 for predictive pre-employment screening according to at least one embodiment of the present disclosure. System 200 comprises user device 210, server 220, database 230, and computer network 260. For purposes of clarity, only one user device 210 is shown in FIG. 2. However, it is within the scope of the present disclosure that the system 200 may include any number of user devices 210 at one time.

The user device 210 may be configured to transmit information to and generally interact with a web service and/or application programming interface infrastructure housed on server 220 over computer network 260. The user device 210 may include a web browser; mobile application, socket or tunnel, or other network connected software such that communication with the web services infrastructure on server 220 is possible over the computer network 260.

User device 210 includes one or more computers, smartphones, tablets, wearable technology, computing devices, or systems of a type well known in the art, such as a mainframe computer, workstation, personal computer, laptop computer, hand-held computer, cellular telephone, or personal digital assistant. User device 210 comprises such software, hardware, and componentry as would occur to one of skill in the art, such as, for example, one or more microprocessors, memory systems, input/output devices, device controllers, and the like. User device 210 also comprises one or more data entry means (not shown in FIG. 2) operable by users of user device 210 for data entry, such as, for example, voice or audio control, a pointing device (such as a mouse), keyboard, touchscreen, microphone, voice recognition, and/or other data entry means known in the art. User device 210 also comprises a display means (not shown in FIG. 2) which may comprise various types of known displays such as liquid crystal diode displays, light emitting diode display, and the like upon which information may be display in a manner perceptible to the user.

As described above, the server 220 may be configured to receive question and answer pairs, client metadata (i.e. HTTP header), and other information from the user device 210 during execution of any of the methods described herein. In at least one embodiment, the server 220 accesses the database 230 to store information transmitted from the user device 210 or generated through its interaction with the server 220 in the methods and disclosed herein. The server 220 is configured to carry out one or more of the steps of methods described herein.

The user device 210 is further configured to provide input to the server 220 to carry out one or more of the steps of the methods described herein. Server 220 comprises one or more server computers, computing devices, or systems of a type known in the art. Server 220 further comprises such software, hardware, and componentry as would occur to one of skill in the art, such as, for example, microprocessors, memory systems, input/output devices, device controllers, display systems, and the like. Server 220 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 2, server 220 is shown and referred to herein as a single server. However, server 220 may comprise a plurality of servers, virtual infrastructure, or other computing devices or systems interconnected by hardware and software systems know in the art which collectively are operable to perform the functions allocated to server 320 in accordance with the present disclosure.

The database 230 is configured to store healthcare information, patient information, reports, health care insight, and other information generated by the healthcare relationship management system and/or retrieved from one or more information sources. Database 230 is “associated with” server 220. According to the present disclosure, database 230 can be “associated with” server 220 where, as shown in the embodiment in FIG. 2, database 230 resides on server 220. Database 230 can also be “associated with” server 220 where database 230 resides on a server or computing device remote from server 220, provided that the remote server or computing device is capable of bi-directional data transfer with server 220, such as, for example, in Amazon AWS, Rackspace, or other virtual infrastructure, or any business network. In at least one embodiment, the remote server or computing device upon which database 230 resides is electronically connected to server 220 such that the remote server or computing device is capable of continuous bi-directional data transfer with server 220.

For purposes of clarity, database 230 is shown in FIG. 2, and referred to herein as a single database. It will be appreciated by those of ordinary skill in the art that database 230 may comprise a plurality of databases connected by software systems of a type well known in the art, which collectively are operable to perform the functions delegated to database 230 according to the present disclosure. Database 230 may also be part of a distributed data architecture, such as, for example, a Hadoop architecture, for big data services. Database 230 may comprise relational database architecture, noSQL, OLAP, or other database architecture of a type known in the database art. Database 230 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Database 230 retrievably stores information that is communicated to database 230 from user device 210 or server 220.

User device 210 and server 220 communicate via computer network 260. If database 230 is in disparate infrastructure from server 220, database 230 may communicate with server 230 via computer network 260. Computer network 260 may comprise the Internet, but this is not required.

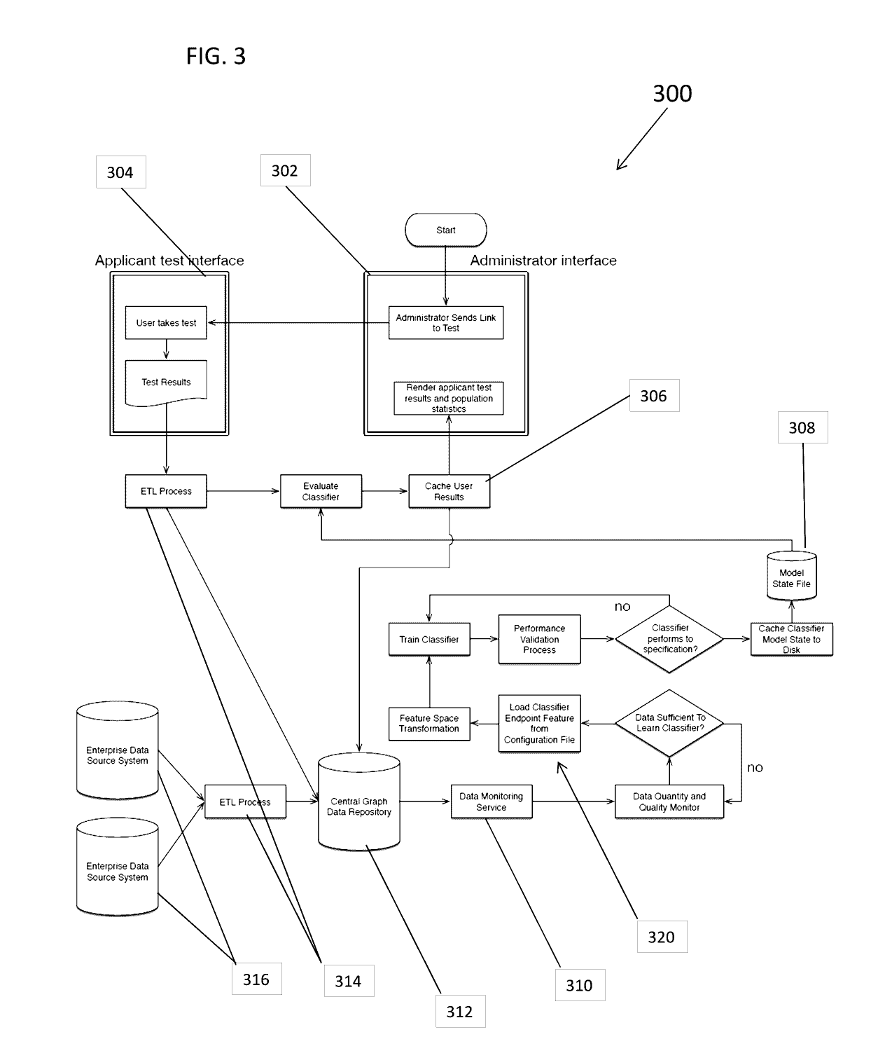

Referring now to FIG. 3, it is shown an architecture and flowchart diagram 300 displaying how information may move between components of a system during execution of one or more of the methods described herein. As shown in FIG. 3, the diagram 300 includes an administrator interface 302, an applicant test interface 304, a flow of information 306, a model state file 308, a validation process 320, a data monitoring service 310, a central graph data repository 312, an ETL process 314, and enterprise data source systems 316.

As shown in FIG. 3, an administrator may send a link to a test for an applicant through the administrator interface 302. The applicant, through the applicant test interface 304, takes the test which produces results that are sent through an ETL process and saved in the central graph data repository 312 in as a graph dataset. As the applicant answers questions at the applicant test interface 304 and generates test results, the results are evaluated against the saved AdBoost classifer and cached 306 to render applicant test results and population statistics (i.e. to provide a recommendation for the applicant).

In addition, the AdBoost classifier may be updated as shown in process 320 mapping newly processed data, loading the classifier from memory, transforming the feature space, and training the classifier. It should be appreciated, then, that the AdBoost classifier may be updated continuously as new data is obtained from the applicant test interface 304 based on applicant activity, including answers to questions and metadata. Ultimately, the updated AdBoost classifier is saved as a model state file 308.

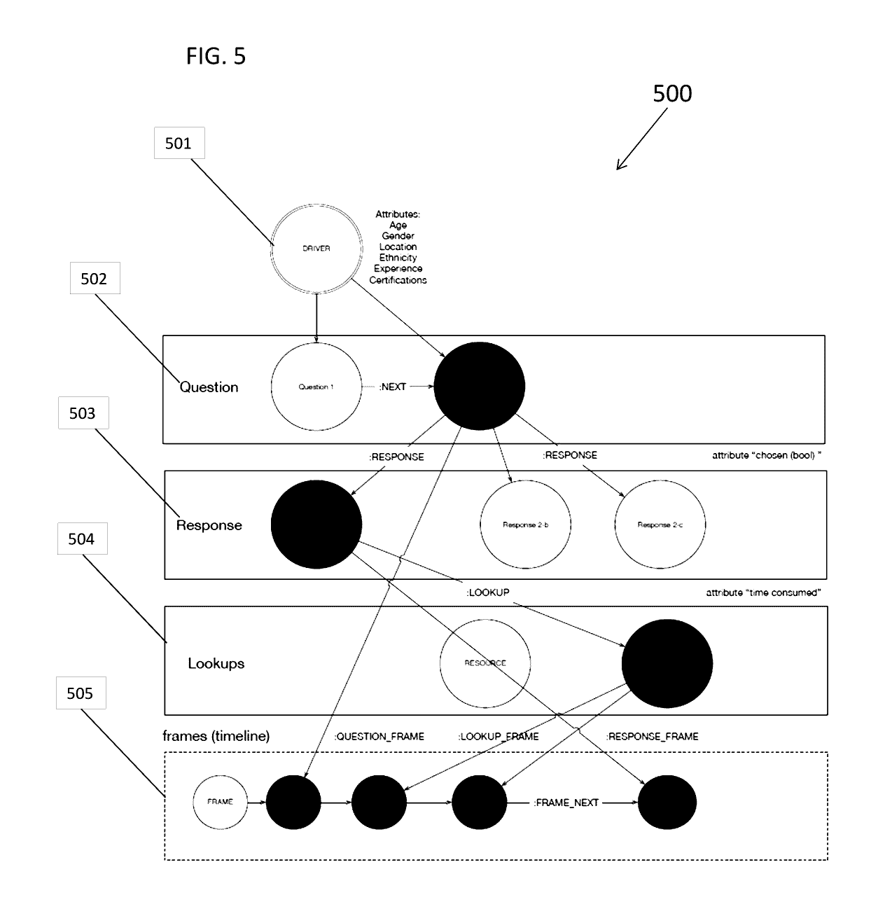

Referring now to FIG. 5, it is shown an example flowchart 500 for dynamically generated questions based on answers to previously issued questions in the truck driving space according to at least one embodiment of the present disclosure. As shown in FIG. 5, a driver 501 provides certain attributes, like age, gender, location, ethnicity, experience, and certifications. The first question of the test is then populated to the applicant at step 502. The user, in step 503, provides a response to that question. After the user provides a response to the initially provided question, lookups are performed against the data set to determine the next appropriate question to ask in step 504. It should be appreciated that these lookups may derive attributes about the candidate through responses to the question and, in turn, dynamically identify appropriate questions based on such responses. For example, if the question asks the applicant whether he or she is a smoker and the response is that the user is a smoker, then that response may be used to ask the user additional questions regarding smoking activity (i.e. does the applicant smoke while driving, etc.).

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for pre-employment predictive screening, the method comprising:
aggregating a plurality of employee testing and demographic data in a database;
mapping each data in the plurality of employee testing and demographic data to a faceted feature space;
selecting a classifying facet group from the faceted feature space;
training a classifier model based at least in part on the classifying facet group; and
saving the classifier model to a memory.

2. The method of claim 1, wherein the classifier model is an Boosting classifier model.

3. The method of claim 1, further comprising:
receiving, at an applicant test interface, a response to a pre-employment question;
deriving, based at least in part on the receiving step, a metadata associated with the response; and
updating the faceted feature space based at least in part on the response and the metadata.

4. The method of claim 3, further comprising re-training the classifier model based at least in part on the updated faceted feature space.

5. The method of claim 3, wherein the metadata comprises a subset of information from an HTTP header associated with the receiving step.

6. The method of claim 3, wherein the metadata comprises a time based at least in part on the response.

7. A computerized method for pre-employment predictive screening, the method comprising:
transmitting a first application question to an applicant at an applicant interface;
receiving a first response from the applicant interface, the first response being associated with the first application question;
evaluating the first response against a question map, the question map identifying a second application question based on the first response; and
transmitting the second application question to the applicant at the applicant interface.

8. The method of claim 7, wherein the response further comprises a metadata.

9. The method of claim 8, wherein the metadata comprises a subset of information from an HTTP header associated with the receiving step.

10. The method of claim 8, wherein the metadata comprises a time based at least in part on the response.

11. The method of claim 7, further comprising:
receiving a second response from the applicant interface, the second response being associated with the second application question;
aggregating the first response and the second response in a database of applicant responses;
mapping each of the first response and the second response to a faceted feature space;
selecting a classifying facet group from the faceted feature space;
training a classifier model based at least in part on the classifying facet group; and
saving the classifier model to a memory.

12. The method of claim 11, wherein the classifier model is an Boosting classifier model.

13. A system, the system comprising:
a database,
a server electronically coupled to the database, the server configured to aggregate a plurality of employee testing and demographic data in a database, map each data in the plurality of employee testing and demographic data to a faceted feature space, select a classifying facet group from the faceted feature space, train a classifier model based at least in part on the classifying facet group, and save the classifier model to a memory.

14. The system of claim 13, wherein the classifier model is an Boosting classifier model.

15. The system of claim 13, wherein the server further comprises an applicant test interface and is further configured to receive, at the applicant test interface, a response to a pre-employment question, derive, based at least in part on the receiving step, a metadata associated with the response, and update the faceted feature space based at least in part on the response and the metadata.

16. The system of claim 15, wherein the server is further configured to re-train the classifier model based at least in part on the updated faceted feature space.

17. The system of claim 15, wherein the metadata comprises a subset of information from an HTTP header associated with the receiving step.

18. The system of claim 15, wherein the metadata comprises a time based at least in part on the response.
